(19) United States
(12) Patent Application Publication
(10) Pub. No.: US 2024/0387878 A1
(43) Pub. Date: Nov. 21, 2024

(54) LITHIUM SECONDARY BATTERY

(71) Applicant: NGK INSULATORS, LTD., Nagoya-City (JP)

(72) Inventors: Ken SHIMAOKA, Nagoya-City (JP); Kengo OISHI, Nagoya-City (JP); Shigeki OKADA, Nagoya-City (JP)

(73) Assignee: NGK INSULATORS, LTD., Nagoya-City (JP)

(21) Appl. No.: 18/787,052

(22) Filed: Jul. 29, 2024

Related U.S. Application Data
(63) Continuation of application No. PCT/JP2022/047935, filed on Dec. 26, 2022.

(30) Foreign Application Priority Data
Feb. 24, 2022 (JP) 2022-027151

(51) Int. Cl. H01M 10/0583; H01M 10/052; H01M 50/109; H01M 50/11

(52) U.S. Cl. CPC H01M 10/0583; H01M 10/052; H01M 50/109; H01M 50/11

(57) ABSTRACT

Provided is a lithium secondary battery including a sintered body, the sintered body including a laminate portion which includes a positive electrode layer, a negative electrode layer, and a separator, and in which the positive electrode layer and the negative electrode layer are laminated through the separator. The sintered body includes an insulating ceramic portion covering at least a part of a peripheral end of the laminate portion and extending across at least a part of a laminate structure exposed at the peripheral end of the laminate portion.

### TECHNICAL FIELD

The present disclosure relates to a lithium secondary battery. This application claims priority from Japanese Patent Application No. 2022-027151, filed on Feb. 24, 2022, the contents of which are incorporated herein by reference in their entirety.

### BACKGROUND ART

There has been known a lithium secondary battery including: a positive electrode layer including a sintered body of a lithium composite oxide; a negative electrode layer including a sintered body containing titanium; and a ceramic separator arranged between the positive electrode layer and the negative electrode layer. For example, in Patent Literature 1, there is a disclosure of a lithium secondary battery including an electrode including an integrated sintered plate in which a positive electrode layer, a ceramic separator, and a negative electrode layer are bonded to each other.

In Patent Literature 2, there is a disclosure of an all-solid-state battery including a laminate in which a plurality of positive electrode layers and a plurality of negative electrode layers are alternately laminated through a solid electrolyte layer. The laminate as disclosed in Patent Literature 2 has a feature in that a buffer layer is provided in the solid electrolyte layer. In the laminate as disclosed in Patent Literature 2, in plan view from a laminating direction, one of each of the positive electrode layers and each of the negative electrode layers is exposed at each of a pair of end portions, and an external terminal is connected to each of the pair of end portions.

### CITATION LIST

### Patent Literature

[PTL 1] WO 2019/221144 A1
[PTL 2] JP 2021-27044 A

### SUMMARY OF INVENTION

### Technical Problem

It is desired for the lithium secondary battery to have a large discharge capacity and a small self-discharge.

In view of the foregoing, an object of the invention according to the present disclosure is to provide a lithium secondary battery having a large discharge capacity and a small self-discharge.

### Solution to Problem

According to an embodiment of the present disclosure, there is provided a lithium secondary battery including a sintered body, the sintered body including a laminate portion which includes a positive electrode layer, a negative electrode layer, and a separator, and in which the positive electrode layer and the negative electrode layer are laminated through the separator. The sintered body includes an insulating ceramic portion covering at least a part of a peripheral end of the laminate portion and extending across at least a part of a laminate structure exposed at the peripheral end of the laminate portion.

### Advantageous Effects of Invention

According to the lithium secondary battery described above, a lithium secondary battery having a large discharge capacity and a small self-discharge is provided.

### BRIEF DESCRIPTION OF DRAWINGS

FIG. 1 is a schematic sectional view for illustrating a lithium secondary battery according to the present disclosure.

FIGS. 2A and 2B are schematic perspective views for illustrating a sintered body included in the lithium secondary battery according to the present disclosure. FIG. 2A is a perspective view of an external appearance, and FIG. 2B is a schematic view for illustrating an internal structure.

FIG. 3 is a schematic sectional perspective view for illustrating a laminate portion in the sintered body included in the lithium secondary battery according to the present disclosure.

FIGS. 4A, 4B and 4C are schematic views for illustrating a part of a process of producing the sintered body included in the lithium secondary battery according to the present disclosure.

FIGS. 5A and 5B are schematic views for illustrating a part of the process of producing a sintered body included in the lithium secondary battery according to the present disclosure.

FIGS. 6A and 6B are schematic views for illustrating a state in a process of producing a sintered body included in the lithium secondary battery according to the present disclosure.

FIGS. 7A and 7B are schematic views for illustrating a state in the process of producing the sintered body included in the lithium secondary battery according to the present disclosure.

FIGS. 8A, 8B, 8C and 8D are schematic views for illustrating a part of a process of producing a sintered body included in the lithium secondary battery according to the present disclosure.

FIG. 9 is a schematic perspective view for illustrating an external appearance of the lithium secondary battery according to the present disclosure.

### DESCRIPTION OF EMBODIMENTS

### Outline of Embodiments

First, embodiments of the present disclosure are listed and described. A lithium secondary battery according to the present disclosure includes a sintered body. The sintered body includes a laminate portion which includes a positive electrode layer, a negative electrode layer, and a separator, and in which the positive electrode layer and the negative electrode layer are laminated through the separator. The sintered body includes an insulating ceramic portion covering at least a part of a peripheral end of the laminate portion and extending across at least a part of a laminate structure exposed at the peripheral end of the laminate portion.

Hitherto, there has been known a lithium secondary battery including a positive electrode layer including a lithium composite oxide sintered body, a negative electrode layer including a titanium-containing sintered body, and a ceramic separator arranged between the positive electrode layer and the negative electrode layer. A collector is connected to each of the positive electrode layer and the negative electrode layer so that an electrode is formed. In the lithium secondary battery as disclosed in Patent Literature 1, a positive electrode-side collector is connected to a lower surface of the positive electrode layer through a conductive carbon layer, and a negative electrode-side collector is connected to an upper surface of the positive electrode layer through a conductive carbon layer. Those collectors are arranged so as to cover main surfaces of the positive electrode layer and the negative electrode layer. Meanwhile, at a peripheral end of the sintered body including the positive electrode layer, the separator, and the negative electrode layer, end surfaces of the positive electrode layer, the separator, and the negative electrode layer are exposed.

Incidentally, in order to improve preservative quality and durability of the lithium secondary battery or a product including the lithium secondary battery, similarly to batteries of other types, the lithium secondary battery is also desired to be reduced in self-discharge. Accordingly, the inventors of the present disclosure have conducted studies aiming to obtain a lithium secondary battery having a small self-discharge while maintaining a high capacity obtained in a battery including an electrode formed of a sintered body. Then, the inventors of the present disclosure have found that the self-discharge can be remarkably reduced while the high capacity is maintained similarly to the related art by covering the peripheral end of the laminate portion, at which the laminate structure has been exposed in the related art, with an insulating ceramic portion. Without being bound to any particular theory, the reason why the self-discharge is reduced is considered as follows. With a structure in which the peripheral end of the laminate portion is covered with the insulating ceramic portion, minute deformation of the laminate structure that may be caused in the production process is suppressed, and thus intervals between the positive electrode layer, the separator, and the negative electrode layer are accurately kept.

In the lithium secondary battery, the insulating ceramic portion may be sintered integrally with the laminate portion. When the laminate portion and the insulating ceramic portion are sintered integrally with each other, the effect obtained by providing the insulating ceramic portion can be reliably obtained, and the electrode can be efficiently and stably produced.

In the lithium secondary battery, the insulating ceramic portion and the separator may be formed of the same composition. When the insulating ceramic portion and the separator are formed of the same composition, the electrode can be efficiently produced. Further, delamination at the time of sintering is less liable to occur, and the electrode can be stably produced.

In the lithium secondary battery, the sintered body may have a surface including: a surface covered with the insulating ceramic portion; a surface at which the positive electrode layer is exposed and the negative electrode layer is not exposed; and a surface at which the negative electrode layer is exposed and the positive electrode layer is not exposed. With this configuration, a configuration in which the positive electrode collector and the negative electrode collector are arranged on the surface at which the positive electrode layer is exposed and the surface at which the negative electrode layer is exposed, respectively, and the end surfaces of the positive electrode layer and the negative electrode layer are prevented from being exposed at a surface of the electrode can be obtained. With this structure, the self-discharge can be reduced more reliably.

In the lithium secondary battery, the laminate portion may include a plurality of positive electrode layers, a plurality of negative electrode layers, and a separator, and the positive electrode layers and the negative electrode layers may be alternately laminated through the separator. That is, the sintered body included in the lithium secondary battery may be a multi-layer laminating-type sintered body in which a plurality of cells are included in one sintered body. In general, as the number of layers in the sintered body is increased, it becomes more difficult to accurately keep the interval between the layers. However, when the insulating ceramic portion is included on the peripheral end of the laminate portion, it becomes easier to accurately keep the interval between the layers. Accordingly, an electrode having a small self-discharge can be obtained even with the multi-layer laminating-type sintered body.

In the lithium secondary battery, the positive electrode layer may include a lithium composite oxide sintered body, and the negative electrode layer may include a titanium-containing sintered body. The positive electrode layer including the lithium composite oxide sintered body and the negative electrode layer including the titanium-containing sintered body are known configurations. A lithium secondary battery in which the self-discharge is suppressed can be obtained more stably by combining this known configuration with the above-mentioned configuration.

### SPECIFIC EXAMPLES OF EMBODIMENTS

Next, specific embodiments of the lithium secondary battery of the present disclosure are described with reference to the drawings. In the following drawings, the same or corresponding portions are given the same reference symbol, and hence their description is not repeated. Further, in each of the drawings, members of the same kind are represented by the same kind of hatching, and hence the representation of some reference symbols in the repeated structure is omitted.

### First Embodiment

### (Lithium Secondary Battery)

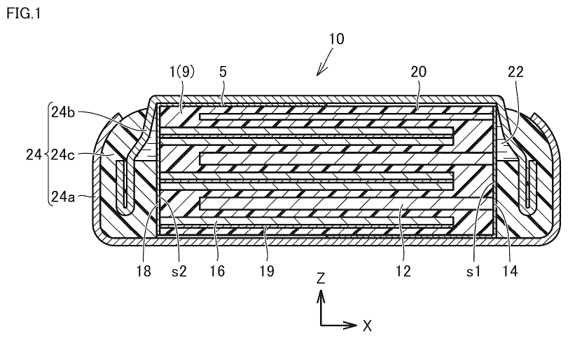

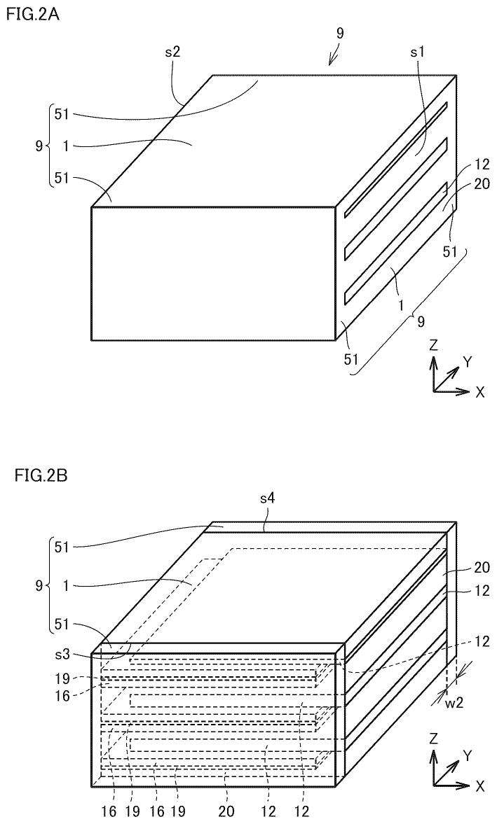

First, the outline of the lithium secondary battery according to the present disclosure is described. FIG. 1 is a schematic sectional view for illustrating the structure of a lithium secondary battery 10, which is an example of an embodiment according to the present disclosure. FIG. 2 are schematic perspective views for illustrating a taken-out sintered body 9 included in the lithium secondary battery 10. With reference to FIG. 1 and FIGS. 2, an X-axis direction is referred to as “width direction of a laminate 1 or the sintered body 9,” a Y-axis direction is referred to as “depth direction of the laminate 1 or the sintered body 9,” and a Z-axis direction is referred to as “laminating direction or thickness direction of the laminate 1 or the sintered body 9.” In this description, a surface of the laminate 1 in an uppermost layer in the laminating direction is referred to as “upper surface,” a surface thereof in a lowermost layer in the laminating direction is referred to as “lower surface,” and surfaces thereof at which all of the laminated layers are exposed are referred to as “front surface” and “back surface.” The front surface and the back surface are surfaces parallel to an XZ plane. Further, a surface of the laminate 1 at which its laminate structure is exposed and which extends between the front surface and the back surface and extends along the depth direction is referred to as “side surface.” The side surface is a surface parallel to a YZ plane. Surfaces excluding the upper surface and the lower surface, that is, the front surface and the back surface in addition to the side surface are sometimes also referred to as “side surfaces.” The upper surface, the lower surface, the side surface, and the like are relative names used for the sake of description herein, and it should be understood that the arrangement direction and the usage direction in the lithium secondary battery are not limited to those directions.

With reference to FIG. 1, the lithium secondary battery 10 includes an electrode 5 stored in an exterior body 24. The electrode 5 includes the sintered body 9, and a positive electrode collector 14 and a negative electrode collector 18 attached to both side surfaces of the sintered body 9, respectively. The sintered body 9 includes the laminate 1 serving as a laminate portion, and an insulating layer 51 (FIG. 2) serving as an insulating ceramic portion extending on a peripheral end of the laminate 1. The laminate 1 includes a plurality of positive electrode layers 12, a plurality of negative electrode layers 16, and a separator 20 being laminated. The laminate 1 and the insulating layer 51 form the sintered body 9 which is one integrated sintered body as a whole.

In the laminate 1, the positive electrode layers 12 and the negative electrode layers 16 are alternately stacked on each other in the laminating direction. The separator 20 is interposed between the positive electrode layer 12 and the negative electrode layer 16. The positive electrode layer 12 and the negative electrode layer 16 are separated from each other by the separator 20. The positive electrode layer 12 is formed of, for example, a sintered body containing a lithium cobalt oxide. The negative electrode layer 16 is formed of, for example, a titanium-containing sintered body. The separator 20 is made of a ceramic.

The exterior body 24 has a closed space formed therein. The electrode 5 and an electrolytic solution 22 are stored in the closed space. The lithium secondary battery 10 has the electrolytic solution 22 sealed inside of the exterior body 24. The positive electrode layers 12, the negative electrode layers 16, and the separator 20 are also impregnated with the electrolytic solution 22.

The exterior body 24 only needs to be appropriately selected in accordance with the type of the lithium secondary battery 10. For example, when the lithium secondary battery 10 is in a coin battery form as illustrated in FIG. 1, the exterior body 24 typically includes a positive electrode can 24a, a negative electrode can 24b, and a gasket 24c. The positive electrode can 24a and the negative electrode can 24b are caulked through the gasket 24c to form the closed space. The positive electrode can 24a and the negative electrode can 24b may each be made of a metal such as stainless steel, and are not limited thereto. The gasket 24c may be a circular member made of an insulating resin, such as polypropylene, polytetrafluoroethylene, or a PFA resin, and is not particularly limited.

Although the lithium secondary battery 10 illustrated in FIG. 1 is in a coin battery form, the form of the lithium secondary battery according to the present disclosure is not limited to a coin battery. For example, other forms such as thin secondary batteries including a chip secondary battery and a pouch secondary battery are permitted. When the lithium secondary battery is a chip-type battery that can be built in a card, it is preferred that its exterior body be a resin substrate, and its battery elements (i.e., the electrode 5 and the electrolytic solution 22) be embedded in the resin substrate. When the lithium secondary battery is a pouch secondary battery, for example, the battery elements may be sandwiched between a pair of resin films. The pair of resin films may be bonded to each other with an adhesive. In addition, in the pair of resin films, the resin films may be thermally fused to each other by hot pressing. Further, the following configuration is permitted: a separator including a solid electrolyte is adopted as the separator, and the separator is free of an electrolytic solution.

With reference to FIG. 1, the electrode 5 of the lithium secondary battery 10 includes a positive electrode collector 14 connected to the sintered body 9 from a side surface of the sintered body 9 to the lower surface thereof. In addition, the lithium secondary battery 10 includes a negative electrode collector 18 connected to the sintered body 9 from another side surface of the sintered body 9 to the upper surface thereof. The positive electrode collector 14 and the negative electrode collector 18 may each be metal foil, such as copper foil or aluminum foil. A carbon layer (not shown) is preferably provided between the positive electrode collector 14 and the sintered body 9 and between the negative electrode collector 18 and the sintered body 9 from the viewpoint of reducing a contact resistance. The carbon layer preferably includes conductive carbon. The carbon layers may each be formed by, for example, applying a conductive carbon paste to the surface of metal foil to be used as a collector.

### (Sintered Body)

The sintered body included in the lithium secondary battery according to the present disclosure is described. FIG. 2 are schematic perspective views for illustrating the sintered body 9 included in the lithium secondary battery according to the present disclosure. FIG. 2A shows the external appearance, and FIG. 2B is a schematic view for illustrating the configuration of the layers included in the sintered body 9, including the internal structure.

With reference to FIG. 2B, the sintered body 9 includes the laminate 1 serving as the laminate portion formed by stacking the plurality of positive electrode layers 12, the plurality of negative electrode layers 16, and the separator 20 in the Z-axis direction (thickness direction). With reference to FIG. 2A and FIG. 2B, a first side surface s1 within a peripheral end of the laminate 1 is a surface at which the positive electrode layers 12 and the separator 20 are exposed and no negative electrode layer 16 is exposed. A second side surface s2 within the peripheral end of the laminate 1 is a surface at which the negative electrode layers 16 and the separator 20 are exposed and no positive electrode layer 12 is exposed. In the sintered body 9, the first side surface s1 and the second side surface s2 of the laminate 1 are exposed to the outside to form the surface of the sintered body 9.

Meanwhile, with reference to FIG. 2B, a third side surface s3 and a fourth side surface s4 within the peripheral end of the laminate 1 are surfaces at which end surfaces of the positive electrode layers, the negative electrode layers, and the separator appear. That is, at the third side surface s3 and the fourth side surface s4, a laminate structure including the positive electrode layers, the negative electrode layers, and the separator appear. Moreover, the third side surface s3 and the fourth side surface s4 are each covered with the insulating layer 51 serving as the insulating ceramic portion. That is, the third side surface s3 and the fourth side surface s4 are surfaces not exposed to the outside because the third side surface s3 and the fourth side surface s4 are each covered with the insulating layer 51 in the sintered body 9.

The peripheral end of the laminate portion herein means, out of the surfaces of the laminate 1, surfaces positioned at an outer periphery, excluding the upper surface and the lower surface in the laminating direction.

In the example illustrated in FIGS. 2, the sintered body 9 has a rectangular parallelepiped shape (rectangular shape), but an outer shape of the sintered body is not limited thereto. For example, the outer shape of the sintered body may be a cylindrical shape (round shape) having side surfaces or other prism shapes. Further, the insulating layer 51 covers the entirety of each of the third side surface s3 and the fourth side surface s4, but a mode in which the insulating layer 51 covers only a part of the third side surface s3 and the fourth side surface s4 is also permitted.

### (Laminate Portion)

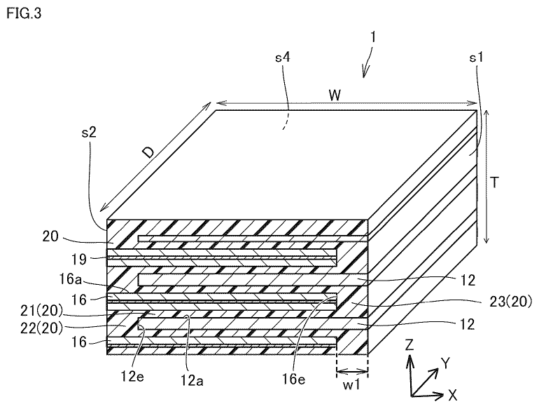

The laminate portion included in the lithium secondary battery according to the present disclosure is described. FIG. 3 is a schematic sectional perspective view for illustrating the laminate 1 serving as the laminate portion included in the lithium secondary battery according to the present disclosure. With reference to FIG. 3, the laminate 1 is a laminate in which many layers are laminated. The laminate 1 is a rectangular parallelepiped shape whose outer shape is defined by a width W, a depth D, and a thickness T. The term “rectangular parallelepiped” as used herein means not only a rectangular parallelepiped in a mathematically correct sense, but also includes a three-dimensional structure having a shape similar to the rectangular parallelepiped because of reasons in terms of design and production.

With reference to FIG. 3, the separator 20 is exposed at both of the upper surface and the lower surface of the laminate 1. In the laminate 1, the positive electrode layer 12 and the negative electrode layer 16 opposed to each other through the separator 20 form one cell. In the laminate 1 of FIG. 3, five cells are formed. Although the number of cells in the laminate included in the lithium secondary battery according to the present disclosure is not limited as long as the laminate has the effects of the invention, a laminate including, for example, three to two-hundred cells may be adopted.

In the laminate 1, the plurality of positive electrode layers 12 and the plurality of negative electrode layers 16 are alternately laminated. Each of the negative electrode layers 16 includes a collector layer 19 on one of main surfaces thereof or inside thereof in the thickness direction. The positive electrode layers 12 and negative electrode layers 16 for forming the laminate 1 each have a quadrangular plate shape. The positive electrode layers 12 and the negative electrode layers 16 each have a width smaller than the width W of the laminate 1. That is, the positive electrode layers 12 and the negative electrode layers 16 are each not present across the entire region of the width W of the laminate 1. Each of the positive electrode layers 12 and each of the negative electrode layer 16 are arranged at positions shifted from each other in the width direction, and the positive electrode layers 12 and the negative electrode layers 16 are each exposed at only one of the first side surface s1 and the second side surface s2 opposed to each other in the laminate 1. Specifically, all of the plurality of positive electrode layers 12 are exposed at the first side surface s1 of the laminate 1, but are not exposed at the second side surface s2. Each of the positive electrode layers 12 extends from the side surface s1 to the middle in the width direction of the laminate 1, and has an inner end surface 12e serving as a terminal in the width direction. Further, all of the plurality of negative electrode layers 16 are exposed at the second side surface s2 of the laminate 1, but are not exposed at the first side surface s1. Each of the negative electrode layers 16 extends from the side surface s2 to the middle in the width direction of the laminate 1, and has an inner end surface 16e serving as a terminal in the width direction.

The separator 20 is interposed between the positive electrode layer 12 and the negative electrode layer 16. The separator 20 includes a first region 21, a second region 22, and a third region 23. The first region extends across the entire width W of the laminate 1, and is interposed between the positive electrode layer 12 and the negative electrode layer 16 in the thickness direction of the laminate 1. The second region 22 is arranged side by side with the positive electrode layer 12 in the X-axis direction, and extends between the side surface s2 and the inner end surface 12e of the positive electrode layer 12. The second region 22 functions as an insulating layer for insulating between the positive electrode layer 12 and the side surface s2. The third region 23 is arranged side by side with the negative electrode layer 16 in the X-axis direction, and extends between the side surface s1 and the inner end surface 16e of the negative electrode layer 16. The third region 23 functions as an insulating layer for insulating between the negative electrode layer 16 and the side surface s1. The first region 21, the second region 22, and the third region 23 are continuous in series without a boundary. The first region 21, the second region 22, and the third region 23 are regions divided for the sake of convenience of description, and the separator 20 is preferably an integrated structure that is continuous as a whole.

Next, the configuration of each layer included in the sintered body 9 and the electrolytic solution 22 included in the lithium secondary battery 10 are described.

### (Positive Electrode Layers)

The positive electrode layers 12 each include a sintered body containing a lithium cobalt oxide. The positive electrode layers 12 may each be free of a binder and a conductive aid. The lithium cobalt oxide is specifically, for example, LiCoO₂ (hereinafter sometimes abbreviated as “LCO”). For example, sintered bodies as disclosed in JP 5587052 B2 and WO 2017/146088 A1 may each be used as an LCO sintered body to be formed into a plate shape. The positive electrode layers 12 are each preferably the following oriented positive electrode layer: the positive electrode layer contains a plurality of primary particles each including a lithium cobalt oxide, and the plurality of primary particles are oriented at an average orientation angle of more than 0° and 30° or less with respect to the layer surface of the positive electrode layer. Examples of the structure, composition, and identification method of such oriented positive electrode layer include those disclosed in Patent Literature 1 (WO 2019/221144 A1).

Examples of the lithium cobalt oxide for forming the primary particles in each of the positive electrode layers 12 include, in addition to LCO, LixNiCoO₂ (lithium nickel cobalt oxide), LixCoNiMnO₂ (lithium cobalt nickel manganese oxide), and LixCoMnO₂ (lithium cobalt manganese oxide). In addition, the primary particles may each contain any other lithium composite oxide together with the lithium cobalt oxide. The lithium composite oxide is, for example, an oxide represented by LixMO₂ (where 0.05<x<1.10 is satisfied, M represents at least one kind of transition metal, and M typically contains one or more kinds of Co, Ni, and Mn).

When the positive electrode layer 12 includes a plate-like sintered body containing LCO, a transition metal element out of the elements for forming each of the positive electrode layers is Co. In addition, when the positive electrode layer 12 includes a sintered body containing LixNiCoO₂ (lithium nickel cobalt oxide), transition metal elements out of the elements for forming each of the positive electrode layers are Ni and Co. In addition, when the positive electrode layer 12 includes a sintered body containing LixCoNiMnO₂ (lithium cobalt nickel manganese oxide), transition metal elements out of the elements for forming each of the positive electrode layers are Ni, Co, and Mn. In addition, the same holds true for a positive electrode except for the lithium cobalt oxide-based positive electrode. For example, when the positive electrode includes LifePO₄ (lithium iron phosphate), the transition metal element out of the elements for forming each of the positive electrode layers is Fe. Further, the transition metal element for forming each of the positive electrode layers may be V (vanadium) or other transition metal elements.

The average particle diameter of the plurality of primary particles for forming each of the positive electrode layers 12 is preferably 5 μm or more. Specifically, the average particle diameter of the primary particles to be used in the calculation of the average orientation angle is preferably 5 μm or more, more preferably 7 μm or more, still more preferably 12 μm or more.

The positive electrode layers 12 may each include pores. When a sintered body includes pores, in particular, open pores, in the case where the sintered body is incorporated as a positive electrode layer into a battery, an electrolytic solution can be caused to permeate into the sintered body, and as a result, lithium ion conductivity can be improved. A porosity in each of the positive electrode layers 12 is preferably from 20% to 60%, more preferably from 25% to 55%, still more preferably from 30% to 50%, particularly preferably from 30% to 45%. The porosity of a sintered body may be measured in accordance with a known method.

The average pore diameter of each of the positive electrode layers 12 is preferably from 0.1 μm to 10.0 μm, more preferably from 0.2 μm to 5.0 μm, still more preferably from 0.25 μm to 3.0 μm. When the average pore diameter falls within the above-mentioned ranges, the occurrence of local stress concentration in a large pore is suppressed, and hence stress in the sintered body is uniformly released with ease. In addition, an improvement in lithium ion conductivity by the permeation of the electrolytic solution into the sintered body through its pores can be more effectively achieved.

Although the thickness of each of the positive electrode layers 12 in the laminate 1 is not particularly limited, the thickness is, for example, preferably from 2 μm to 200 μm, more preferably from 5 μm to 120 μm, still more preferably from 10 μm to 80 μm. When the thickness falls within such ranges, the electronic resistance of the layer is suppressed, and the transfer resistance of a Li ion in the electrolytic solution is also suppressed. Thus, there is an advantage in that the resistance of the battery can be reduced.

### (Separator)

The separator 20 includes a ceramic-made fine porous membrane. The separator 20 contains magnesia (MgO).

Specifically, the separator may include, for example, magnesia (MgO) and glass. In the separator 20, MgO and the glass are present in particle forms bonded to each other by sintering. The ceramic in the separator 20 may contain, for example, Al₂O₃, Zro₂, SiC, Si₃N₄, or AlN in addition to MgO and the glass.

The glass in the separator 20 contains preferably 25 wt % or more, more preferably 30 wt % to 95 wt %, still more preferably 40 wt % to 90 wt %, particularly preferably 50 wt % to 80 wt % of SiO₂. The content of the glass in the separator 20 is preferably from 3 wt % to 70 wt %, more preferably from 5 wt % to 50 wt %, still more preferably from 10 wt % to 40 wt %, particularly preferably from 15 wt % to 30 wt % with respect to the total weight of the separator 20. When the content falls within the ranges, both of a high yield and an excellent charge-discharge cycle characteristic can be effectively achieved. The addition of a glass component to the separator 20 is preferably performed by adding a glass frit to raw material powder for the separator. The glass frit preferably contains one or more of Al₂O₃, B₂O₃, and BaO as a component except SiO₂.

Although the thickness of the separator 20 in the laminate 1 is not particularly limited, for example, the thickness of the first region 21 (region between the positive electrode layer 12 and the negative electrode layer 16) of the separator 20 is preferably from 5 μm to 60 μm, more preferably from 10 μm to 30 μm. The thicknesses of the second region 22 and the third region 23 of the separator 20 may be equal to those of the positive electrode layer 12 and the negative electrode layer 16, respectively. Although the porosity of the separator 20 is also not particularly limited, the porosity may be set to, for example, from about 30% to about 70%, and is preferably from about 40% to about 60%.

### (Negative Electrode Layers)

The negative electrode layers 16 each include, for example, a plate-like sintered body containing a titanium-containing composition. The negative electrode layers 16 may each be free of a binder and a conductive aid. The titanium-containing sintered body preferably contains lithium titanium oxide LiqTi₅O₁₂ (hereinafter “LTO”) or a niobium-titanium composite oxide Nb₂TiO₇, and more preferably contains LTO. Although it has been known that LTO typically has a spinel structure, LTO may have any other structure at the time of the charge and discharge of the lithium secondary battery. For example, in LTO, a reaction advances at the time of the charge and the discharge under a state in which two phases, that is, Li₄TisO₁₂ (spinel structure) and Li₇Ti₅O₁₂ (rock salt structure) coexist. Accordingly, the structure of LTO is not limited to the spinel structure. Part of LTO may be substituted with any other element. Examples of the other element include Nb, Ta, W, Al, and Mg. The LTO sintered body may be produced in accordance with, for example, a method as described in JP 2015-185337 A.

When the negative electrode layers 16 each include a sintered body containing LTO, the transition metal element out of the elements for forming each of the negative electrode layers is Ti. Further, when the negative electrode layers 16 each include a sintered body containing Nb₂TiO₇, the transition metal elements out of the elements for forming each of the negative electrode layers are Nb and Ti.

The negative electrode layers 16 each have a structure in which a plurality of primary particles are bonded to each other. Those primary particles each preferably include LTO or Nb₂TiO₇. The negative electrode layers 16 may be formed as an integrated sintered body together with the positive electrode layers 12 and the separator 20. In addition, the following may be performed: the negative electrode layers 16 are formed as a sintered body different from the integrated sintered body of the positive electrode layers 12 and the separator 20; and then, the sintered bodies are combined with each other.

Although the thickness of each of the negative electrode layers 16 in the laminate 1 is not particularly limited, the thickness is, for example, preferably from 1 μm to 150 μm, more preferably from 2 μm to 120 μm, still more preferably from 5 μm to 80 μm. A primary particle diameter that is the average particle diameter of the plurality of primary particles for forming each of the negative electrode layers 16 is preferably 1.2 μm or less, more preferably from 0.02 μm to 1.2 μm, still more preferably from 0.05 μm to 0.7 μm.

The negative electrode layers 16 each preferably include pores. When a sintered body includes pores, in particular, open pores, in the case where the sintered body is incorporated as a negative electrode layer into a battery, an electrolytic solution can be caused to permeate into the sintered body, and as a result, lithium ion conductivity can be improved. A porosity in each of the negative electrode layers 16 is preferably from 20% to 60%, more preferably from 30% to 55%, still more preferably from 35% to 50%. The average pore diameter of each of the negative electrode layers 16 is preferably from 0.08 μm to 5.0 μm, more preferably from 0.1 μm to 3.0 μm, still more preferably from 0.12 μm to 1.5 μm.

In the laminate 1, the negative electrode layers 16 may each include a collector layer 19. The collector layer 19 may be arranged inside each of the negative electrode layers 16 in its thickness direction, or may be formed so as to be exposed at one of the main surfaces of the negative electrode layer 16. The collector layer 19 may include a material excellent in conductivity. The collector layer 19 may include, for example, gold, silver, platinum, palladium, aluminum, copper, or nickel. The incorporation of the collector layer 19 can reduce the internal resistance of the laminate, in particular, that in its negative electrode.

### (Insulating Ceramic Portion)

The insulating layer 51 included in the sintered body 9 includes an insulating ceramic. Specifically, a ceramic similar to that used as the separator can be used. Although a thickness w2 (FIG. 2B) of the insulating layer 51 is not particularly limited, the thickness is, for example, preferably from 100 μm to 1,000 μm, more preferably from 200 μm to 500 μm. For example, when the insulating layer 51 and the separator 20 are formed of the same composition, the insulating layer and the separator may be integrated in the sintering process so that the insulating layer 51 and the separator 20 become an integrated region without a boundary in the sintered body 9.

The insulating layer 51 is preferably provided so as to cover each of both of the third side surface s3 and the fourth side surface s4 of the laminate 1, but a mode in which the insulating layer 51 covers any one of the third side surface s3 and the fourth side surface s4 is also permitted. Further, the insulating layer 51 preferably covers the entirety of each of the third side surface s3 and the fourth side surface s4, but a mode in which the insulating layer 51 covers only a part thereof is also permitted. The insulating layer 51 extends so as to cover at least a part of the plurality of layers included in the lamination across at least a part of the third side surface s3 and the fourth side surface s4 in the laminating direction.

An effect obtained when the insulating layer 51 is present is considered as follows, without being bound to any particular theory. That is, when the laminate including the positive electrode layers, the separator, and the negative electrode layers is sintered to produce the electrode, at the side surface (third side surface s3 or fourth side surface s4) at which the laminate structure is exposed, slight deformation may occur at the end surface of each of the exposed positive electrode layers 12 and negative electrode layers 16. As a result of the deformation, correct separation by the separator may be prevented from being achieved between the positive electrode layer and the negative electrode layer, and this state has been considered to be a cause of the self-discharge. In contrast, when the insulating layer 51 is further provided on the outer end of the region in which the laminate structure is exposed, at a stage in a production process at which a green sheet laminate is cut to obtain a laminate in a desired shape, the laminate can be obtained by cutting the part of the insulating layer 51 without cutting the laminate structure part in which the positive electrode layers and the negative electrode layers are superimposed. Through use of the insulating layer 51 as a cutting site, a stress at the time of cutting is unlikely to affect the laminate structure. As a result, it is considered that the deformation of the end surface of each of the positive electrode layers 12 and the end surface of each of the negative electrode layers 16 exposed at the third side surface s3 or the fourth side surface s4 is suppressed, and the occurrence of the self-discharge is suppressed as a result.

### (Electrolytic Solution)

With reference to FIG. 1, the lithium secondary battery 10 may include the electrolytic solution 22. The electrolytic solution 22 is not particularly limited, and an electrolytic solution known as an electrolytic solution in a lithium secondary battery may be used. For example, one kind or a combination of two or more kinds selected from ethylene carbonate (EC), methyl ethyl carbonate (MEC), diethyl carbonate (DEC), ethyl methyl carbonate (EMC), propylene carbonate (PC), and γ-butyrolactone (GBL) may be used as a solvent. For example, a lithium salt compound, such as lithium hexafluorophosphate (LiPF₆) or lithium borofluoride (LiBF₄), may be used as an electrolyte dissolved in the solvent. The electrolytic solution 22 may further contain at least one kind selected from vinylene carbonate (VC), fluoroethylene carbonate (FEC), vinyl ethylene carbonate (VEC), and lithium difluoro (oxalato) borate (LiDFOB) as an additive.

The concentration of the electrolyte in the electrolytic solution 22 is preferably from 0.5 mol/L to 2 mol/L, more preferably from 0.6 mol/L to 1.9 mol/L, still more preferably from 0.7 mol/L to 1.7 mol/L, particularly preferably from 0.8 mol/L to 1.5 mol/L.

Further, in addition to the electrolytic solution 22, a solid electrolyte or a polymer electrolyte can be used as the electrolyte. In that case, as in the case of the electrolytic solution 22, at least the inside of each of the pores of the separator 20 is preferably impregnated with the electrolyte. Although a method for the impregnation is not particularly limited, examples thereof include: a method including melting the electrolyte to cause the electrolyte to infiltrate into the pores of the separator 20; and a method including pressing the compact of the electrolyte against the separator 20.

### (Production Method)

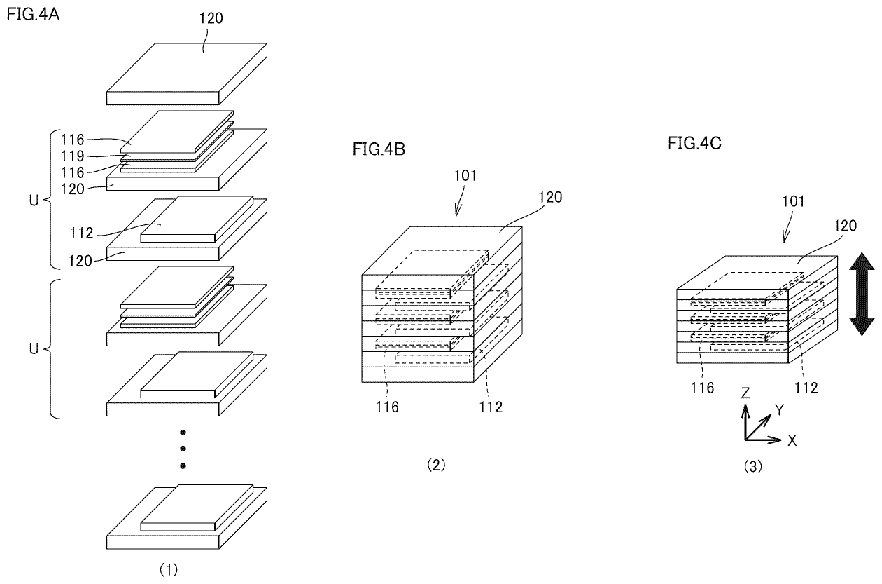

The outline of a method of producing the sintered body included in the lithium secondary battery according to the present disclosure is described. FIGS. 4A-4C schematically show a step of preparing the sheets for forming the laminate and stacking and pressure-bonding the sheets in the process of producing the sintered body.

With reference to part (1) of FIG. 4A, a positive electrode green sheet 112, a negative electrode green sheet 116, and a separator green sheet 120 serving as materials for forming the laminate are each separately prepared. Typically, first, a slurry containing a raw material for forming each layer is prepared, and then, the prepared slurry is formed into a sheet shape on a resin film. Thus, a green sheet can be prepared. A collector layer 119 may be formed on one of the main surfaces of the negative electrode green sheet 116. With reference to part (2) of FIG. 4B, the respective sheets each cut into a predetermined width are sequentially stacked so that a predetermined layer configuration may be obtained. In the example of FIG. 4, the layer configuration is simply illustrated, but a unit U including the negative electrode green sheet 116, the separator green sheet 120, the positive electrode green sheet 112, and the separator green sheet 120 may be repeatedly laminated to obtain a laminate having a larger number of layers.

With reference to part (1) of FIG. 4A, at the time of the stacking, each green sheet may be used alone in the thickness direction, or a form in which two or more sheets of the same kind are continuously superimposed in the thickness direction is also permitted. For example, in order to form the negative electrode layer 16, two negative electrode green sheets 116 each having the collector layer 119 on one surface may be superimposed. When the two negative electrode green sheets 116 each having the collector layer 119 are superimposed, the sheets are preferably superimposed so that the collector layers 119 may be brought into contact with each other. When two or more sheets of the same kind are superimposed in the thickness direction, the superimposed sheets are integrated in their sintering stage, and hence become one layer in a sintered body. With reference to part (2) of FIG. 4B, at the time of lamination, the positive electrode green sheet 112 and the negative electrode green sheet 116 are arranged so as to be shifted from each other in the width direction (X-axis direction). With this arrangement, there can be obtained a configuration in which, out of the pair of side surfaces in the sintered body 9 (FIG. 2), one side surface has the positive electrode layers 12 exposed thereat and has no negative electrode layer 16 exposed thereat, and the other side surface has the negative electrode layers 16 exposed thereat and has no positive electrode layer 12 exposed thereat.

With reference to part (3) of FIG. 4C, a pressure is applied to a green sheet laminate 101 so that the layers are pressure-bonded to each other. Specifically, the green sheets included in the green sheet laminate 101 can be pressure-bonded to each other by pressing. The green sheet laminate 101 is preferably pressed in the thickness direction (Z-axis direction). The method of pressing may be, for example, cold isostatic pressing (CIP), warm isostatic pressing (WIP), or isostatic pressing, and the method is not particularly limited. The pressing may be performed while the green sheet laminate is heated.

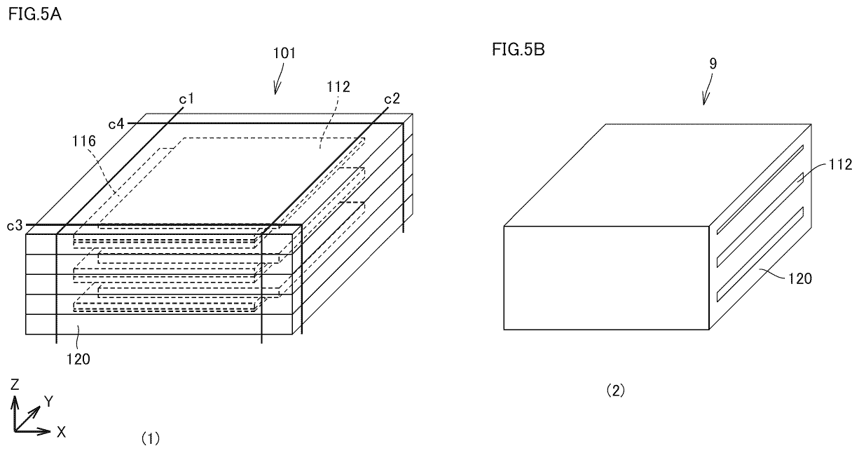

Subsequently, the green sheet laminate 101 is cut. FIGS. 5A-5B shows a part of the process in a case of producing a rectangular-shape sintered body, in which each layer is formed into a quadrangular shape, and which has a rectangular parallelepiped shape as a whole. In part (1) of FIG. 5A, cutting sites c1 to c4 are indicated by thick lines. With reference to part (1) of FIG. 5A, first, both the side surfaces of the green sheet laminate 101 are cut at the cutting sites c1 and c2 so that the green sheet laminate 101 has a predetermined width. The cutting site c2 is a position at which the positive electrode green sheet 112 is cut and no negative electrode green sheet 116 is cut. The cutting site c1 is a position at which the negative electrode green sheet 116 is cut and no positive electrode green sheet 112 is cut. For example, cutting can be performed so that a distance w1 (FIG. 3) from the terminal of each of the positive electrode green sheet 112 and the negative electrode green sheet 116 to the side surface (cutting site c1 or c2) becomes 0.5 mm. Subsequently, the front surface and the back surface of the green sheet laminate 101 are cut at the cutting sites c3 and c4 so that a laminate having a predetermined depth can be obtained. At this time, cutting is performed so that the laminate includes the entire region in the depth direction of each of the positive electrode green sheet 112 and the negative electrode green sheet 116 and the separator green sheet 120 extends on an outer end thereof. That is, the cutting sites c3 and c4 are positions at which only the separator green sheet 120 is cut and no positive electrode green sheet 112 or negative electrode green sheet 116 is cut.

Next, degreasing and firing are performed to provide an integrated sintered body 9 (part (2) of FIG. 5B) including the insulating ceramic portion on the peripheral end of the laminate. The degreasing and the firing may be performed under known conditions and by known methods. The thicknesses and widths of the respective layers in the resultant laminated integrated sintered body may be determined by, for example, polishing the laminated integrated sintered body with a cross section polisher, and observing the resultant section with a SEM.

Subsequently, collectors are attached to both the side surfaces of the sintered body. With reference to FIG. 1, the positive electrode collector 14 is attached to the first side surface s1 of the sintered body 9, and the negative electrode collector 18 is attached to the second side surface s2. A conductive material may be used as the positive electrode collector 14 or the negative electrode collector 18, and for example, aluminum foil or copper foil only needs to be used. The positive electrode collector 14 may be attached so as to cover the entirety of the first side surface s1, and may further be configured to extend to the lower surface of the sintered body 9. The negative electrode collector 18 may be attached so as to cover the entirety of the second side surface s2, and may further be configured to extend to the upper surface of the sintered body 9. The sintered body 9 and the positive electrode collector 14, or the sintered body 9 and the negative electrode collector 18 may be bonded to each other with a conductive adhesive. For example, a conductive carbon paste may be used as the conductive adhesive. The thickness of a conductive adhesive layer is not particularly limited as long as an effect as an adhesive layer is exhibited, and the effects of the invention are not inhibited. However, the thickness may be set to, for example, from about 1 μm to about 500 μm.

An electrode obtained by the above-mentioned production method is placed inside an exterior body in accordance with a known method and known conditions, and an electrolytic solution is sealed therein. Thus, the lithium secondary battery can be obtained.

### Second Embodiment

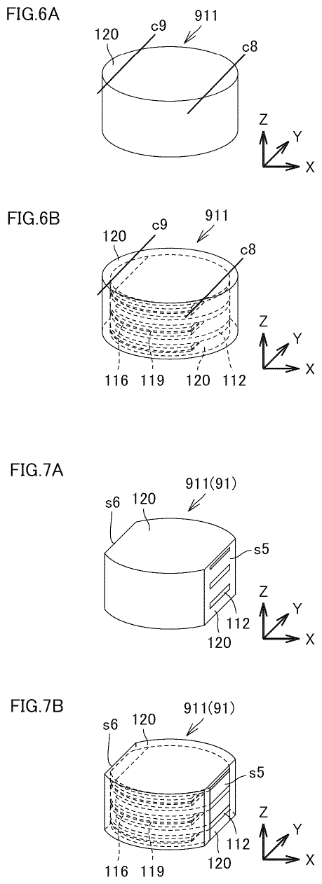

The sintered body for forming the electrode included in the lithium secondary battery according to the present disclosure may be, for example, a round-shape sintered body in addition to the rectangular-shape sintered body described in the first embodiment. FIG. 6 and FIG. 7 show parts of a process of producing a sintered body 91 formed into a round shape to be a cylindrical body as a whole. As illustrated in FIGS. 7, the sintered body 91 has a shape obtained by cutting parts of a column in parallel to a tangent line so that two opposed side surfaces s5 and s6 are formed. This shape is referred to as “round shape.” Although the sintered body 91 is different from the sintered body 9 in shape, other configurations are substantially the same. In the following, differences are mainly described.

FIG. 6A is a perspective view for illustrating an external appearance of a green sheet laminate 911 in the process of producing the sintered body 91, and FIG. 6B is a schematic view for illustrating the laminate structure inside of the green sheet laminate 911. The same green sheets as the various green sheets for forming the green sheet laminate 101 except that the shapes are different can be used as the positive electrode green sheet 112, the negative electrode green sheet 116, and the separator green sheet 120 for forming the respective layers of the green sheet laminate 911. Further, the order of lamination can also be similar to that of the green sheet laminate 101.

With reference to FIG. 6B, each of the positive electrode green sheet 112 and the negative electrode green sheet 116 included in the green sheet laminate 911 has a shape in which a part of a circle is cut off in parallel to a tangent line. The positive electrode green sheet 112 and the negative electrode green sheet 116 are alternately laminated through the circular separator green sheet 120. Further, the positive electrode green sheet 112 and the negative electrode green sheet 116 are arranged so that cut-out sites thereof are positioned on sides opposite to each other. Moreover, the separator green sheet 120 covers the entire peripheral end of the laminate part.

After the lamination and the pressure-bonding of the green sheet laminate 911 are performed, the green sheet laminate 911 is cut. In FIG. 6A and FIG. 6B, cutting sites c8 and c9 are indicated by thick lines. FIG. 7A and FIG. 7B show states after cutting. With reference to FIG. 6 and FIGS. 7, the cutting site c8 is a position at which the positive electrode green sheet 112 is cut without overlapping the negative electrode green sheet 116. Further, the cutting site c8 is parallel to the cut-out portion of the negative electrode green sheet 116. When the green sheet laminate 911 is cut at this position, the side surface s5 at which the positive electrode green sheet 112 and the separator green sheet 120 are exposed in the cross section and no negative electrode green sheet 116 is exposed can be obtained. The cutting site c9 is a position at which the negative electrode green sheet 116 is cut without overlapping the positive electrode green sheet 112. Further, the cutting site c9 is parallel to a cut-out portion of the positive electrode green sheet 112. When the green sheet laminate 911 is cut at this position, the side surface s6 at which the negative electrode green sheet 116 and the separator green sheet 120 are exposed in the cross section and no positive electrode green sheet 112 is exposed can be obtained. Next, the degreasing and the firing are performed so that the integrated sintered body 91 in which the insulating ceramic portion is formed on the peripheral end of the laminate portion can be obtained. Collectors are connected to the respective side surfaces s5 and s6, and assembly is performed in the same manner as in the first embodiment. Thus, the lithium secondary battery can be obtained.

### Third Embodiment

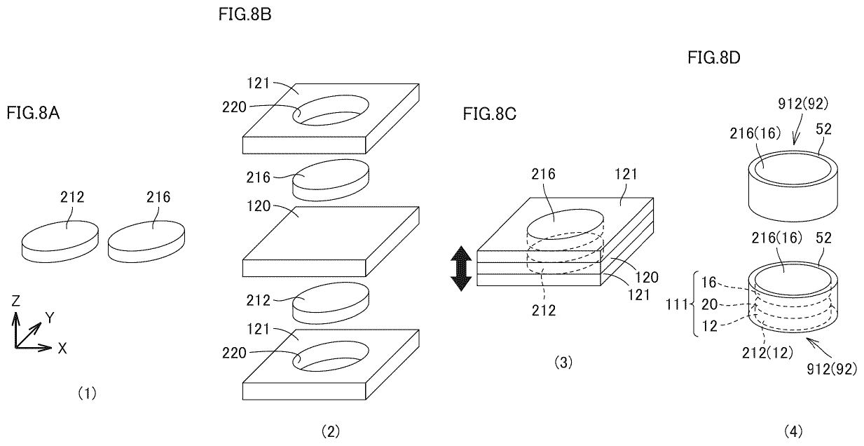

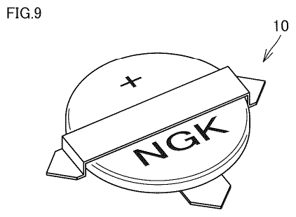

The sintered body for forming the electrode included in the lithium secondary battery according to the present disclosure may be, in addition to a multi-layer laminating-type sintered body described in the first embodiment and the second embodiment, a sintered body in which one positive electrode layer and one negative electrode layer are laminated through a separator. FIG. 8A-8D are schematic views for illustrating a part of a process of producing a sintered body 92 included in the lithium secondary battery according to the present disclosure. With reference to part (4) of FIG. 8D, the sintered body 92 includes a laminate 111 serving as a laminate portion in which one positive electrode layer 12 and one negative electrode layer 16 are laminated through the separator 20. The sintered body 92 has a cylindrical shape. The negative electrode layer 16 is exposed at the upper surface of the sintered body 92, and the positive electrode layer 12 is exposed at the lower surface of the sintered body 92. Further, the entirety of the peripheral end of the laminate 111 included in the sintered body 92 is covered with the insulating layer 52 serving as the insulating ceramic portion. That is, no positive electrode layer or negative electrode layer is exposed at an outer peripheral surface of the sintered body 92. A composition similar to that of the sintered body 9 can be used as a composition for forming each layer included in the sintered body 92.

With reference to FIGS. 8A-8D, an example of the method of producing the sintered body 92 is described. With reference to part (1) of FIG. 8A, a round-shape positive electrode green sheet 212 and a round-shape negative electrode green sheet 216 are prepared. The positive electrode green sheet 212 and the negative electrode green sheet 216 may each be formed of one sheet, or may each be formed by laminating and pressure-bonding a plurality of sheets so as to achieve a desired thickness. Next, with reference to part (2) and part (3) of FIGS. 8B and 8C, a separator green sheet 121 having formed therein a hole 220 having a diameter corresponding to the positive electrode green sheet 212 and the negative electrode green sheet 216, and a separator green sheet 120 without a hole are prepared. The positive electrode green sheet 212 and the negative electrode green sheet 216 are each arranged so as to be accommodated in the hole 220 of the separator green sheet 121, and further the separator green sheet 120 is arranged between the positive electrode green sheet 212 and the negative electrode green sheet 216. After the lamination, compression is executed so that a green sheet laminate 912 is obtained. Next, the green sheet laminate 912 is cut. The cutting site is adjusted so that the green sheet laminate 912 includes the positive electrode green sheet 212 and the negative electrode green sheet 216 and the separator green sheet 120 is positioned at peripheral ends thereof. Thus, the green sheet laminate 912 is cut out into a cylindrical shape. After that, the degreasing and the firing are performed so that the integrated sintered body 92 including the insulating layer 52 on the peripheral end of the laminate 111 is obtained. Collectors are connected to the negative electrode layer 16 exposed at the upper surface of the sintered body 92 and the positive electrode layer 12 exposed at the lower surface of the sintered body 92. Thus, the electrode can be formed. Further, assembly is performed in a known method. Thus, the lithium secondary battery can be obtained.

### EXAMPLES AND COMPARATIVE EXAMPLES

The lithium secondary battery of the present disclosure is described in more detail below by way of Examples and Comparative Examples.

### Example 1

A lithium secondary battery was produced in accordance with a method described in the following sections 1 to 8.

### 1. Production of Laminate

The green sheets of respective layers for forming a sintered body were produced under conditions described in the sections (1) to (3) and by methods described therein. In each of the sections (1) to (3), the viscosity of a slurry was measured with an LVT viscometer manufactured by Brookfield Engineering. At the time of the molding of the slurry on a PET film, a doctor blade method was used.

### (1) Production of LCO Green Sheet (Positive Electrode Green Sheet)

CO₃O₄ powder (manufactured by Seido Chemical Industry Co., Ltd.) and Li₂CO₃ powder (manufactured by the Honjo Chemical Corporation) weighed so that the molar ratio “Li/Co” became 1.01 were mixed, and then, the mixture was held at 780° C. for 5 hours. The resultant powder was pulverized in a pot mill so that a volume-based D₅₀ particle diameter became 0.4 μm. Thus, powder formed of LCO plate-like particles was obtained. 100 Parts by weight of the resultant LCO powder, 100 parts by weight of a dispersion medium (toluene:isopropanol=1:1), 8 parts by weight of a binder (polyvinyl butyral: product number: BM-2, manufactured by Sekisui Chemical Co., Ltd.), 2 parts by weight of a plasticizer (di (2-ethylhexyl) phthalate (DOP), manufactured by Kurogane Kasei Co., Ltd.), and 4.5 parts by weight of a dispersant (product name: RHEODOL SP-O30, manufactured by Kao Corporation) were mixed. The resultant mixture was stirred under reduced pressure to be defoamed, and its viscosity was adjusted to 4,000 cP. Thus, an LCO slurry was prepared. The prepared slurry was molded into a sheet shape on the PET film. Thus, an LCO green sheet was formed. The thickness of a positive electrode layer after its firing was adjusted to 24 μm.

### (2) Production of LTO Green Sheet (Negative Electrode Green Sheet)

100 Parts by weight of LTO powder (volume-based D₅₀ particle diameter: 0.06 μm, manufactured by Sigma-Aldrich Japan K.K.), 100 parts by weight of a dispersion medium (toluene:isopropanol=1:1), 20 parts by weight of a binder (polyvinyl butyral: product number: BM-2, manufactured by Sekisui Chemical Co., Ltd.), 4 parts by weight of a plasticizer (di (2-ethylhexyl) phthalate (DOP), manufactured by Kurogane Kasei Co., Ltd.), and 2 parts by weight of a dispersant (product name: RHEODOL SP-O30, manufactured by Kao Corporation) were mixed. The resultant mixture of negative electrode raw materials was stirred under reduced pressure to be defoamed, and its viscosity was adjusted to 4,000 cP. Thus, an LTO slurry was prepared. The prepared slurry was molded into a sheet shape on the PET film. Thus, an LTO green sheet was formed. The thickness of a negative electrode layer after its firing was adjusted to 10 μm.

### (2′) Formation of Collector Layer

A Au paste (manufactured by Tanaka Kikinzoku Kogyo K.K., product name: GB-2706) was printed on one surface of the LTO green sheet produced in the section (2) with a printer. The thickness of the printed layer after its firing was set to 0.2 μm.

### (3) Production of Separator Green Sheet and Insulating Layer Green Sheet

Magnesium carbonate powder (manufactured by Konoshima Chemical Co., Ltd.) was thermally treated at 900° C. for 5 hours to provide MgO powder. The resultant MgO powder and a glass frit (manufactured by Nippon Frit Co., Ltd., CK0199) were mixed at a weight ratio of 7:3. 100 Parts by weight of the resultant mixture powder (volume-based D₅₀ particle diameter: 0.4 μm), 100 parts by weight of a dispersion medium (toluene:isopropanol=1:1), 30 parts by weight of a binder (polyvinyl butyral: product number: BM-2, manufactured by Sekisui Chemical Co., Ltd.), 6 parts by weight of a plasticizer (di (2-ethylhexyl) phthalate (DOP), manufactured by Kurogane Kasei Co., Ltd.), and 2 parts by weight of a dispersant (product name: RHEODOL SP-O30, manufactured by Kao Corporation) were mixed. The resultant raw material mixture was stirred under reduced pressure to be defoamed, and its viscosity was adjusted to 4,000 cP. Thus, a slurry was prepared. The prepared slurry was molded into a sheet shape on the PET film. Thus, a separator green sheet was formed.

The thickness of a separator layer positioned between the positive electrode layer and the negative electrode layer was adjusted to become 25 μm after firing. The thickness of the separator (insulating layer) positioned adjacent to the positive electrode layer was adjusted to become 24 μm after firing. The thickness of the separator (insulating layer) positioned adjacent to the negative electrode layer was adjusted to become 20 μm after firing.

### 2. Cutting of Sheets

The green sheets obtained in the section 1. were cut in order to laminate the green sheets. The positive electrode green sheet and the negative electrode green sheet were each cut into a rectangular shape of 20 mm×9.5 mm. The separator green sheet was cut into a rectangular shape of 25 mm×25 mm.

### 3. Lamination, Pressure Bonding, and Cutting of Laminate

Various green sheets were laminated as illustrated in [FIG. 4]. When two LTO green sheets were superimposed, the lamination was performed so that their collector layers were brought into contact with each other. The sheets were repeatedly stacked in the order illustrated in FIG. 4 so that the number of cells formed in the laminate became fifteen (FIG. 4 shows only a part of the repetition).

The resultant laminate was pressed by cold isostatic pressing (CIP) at 100 kgf/cm² so that the green sheets were pressure-bonded to each other. Thus, an unfired green sheet laminate was obtained. In the pressing, a pressure was applied in the thickness direction (laminating direction) of the green sheets.

Subsequently, the unfired green sheet laminate was cut with a Thomson blade into a square of 10 mm×10 mm. The cutting positions were, in the width direction of the laminate, positions at which the end surfaces of the positive electrode layer green sheet and the separator green sheet were exposed at one side surface and the end surfaces of the negative electrode layer green sheet and the separator green sheet were exposed at the other side surface. The cutting positions were, in the depth direction of the laminate, positions at which the entirety in the depth direction (9.5 mm) of the positive electrode green sheet and the negative electrode green sheet was included in the laminate after cutting and the thickness of the insulating ceramic portion became a total of 0.5 mm. That is, cutting was performed so that only the separator green sheet was exposed at the front surface and the back surface of the laminate.

### 4. Degreasing and Firing

The green sheet laminate thus cut was degreased for five hours by increasing the temperature from room temperature to 600° C., and was fired by increasing the temperature to 800° C. and holding the laminate for 10 minutes. After that, the laminate was cooled. Thus, a laminated integrated sintered body was obtained.

### 5. Preparation of Conductive Carbon Paste

A binder (CMC: MAC350HC, manufactured by Nippon Paper Industries Co., Ltd.) was weighed so that its concentration became 1.2 wt % with respect to pure water, followed by its dissolution in the water through mixing with a stirrer. Thus, a 1.2 wt % CMC solution was obtained. A carbon dispersion liquid (product number: BPW-229, manufactured by Nippon Graphite Industries, Co., Ltd.) and a dispersing material solution (product number: LB-300, manufactured by Showa Denko K.K.) were prepared. Subsequently, the carbon dispersion liquid, the dispersing material solution, and the 1.2 wt % CMC solution were weighed so that their ratio became 0.22:0.29:1, followed by the mixing of the materials with a rotary and revolutionary mixer. Thus, a conductive carbon paste was prepared.

### 6. Joining of Positive Electrode Exposed Surface of Laminated Integrated Sintered Body and Aluminum Foil via Conductive Carbon Paste

The conductive carbon paste obtained in the section 5. was printed on aluminum foil serving as a positive electrode collector by screen printing. The positive electrode exposed surface of the laminated integrated sintered body obtained in the section 4. was mounted so that the positive electrode exposed surface was bonded within the undried printed pattern (region having applied thereto the conductive carbon paste). The laminated integrated sintered body and the aluminum foil were lightly pressed down with a finger, and then, the resultant was dried in a vacuum at 50° C. for 60 minutes. Thus, the positive electrode exposed surface of the laminated integrated sintered body and the positive electrode collector were bonded to each other via the conductive carbon adhesion layer. The thickness of the conductive carbon adhesive layer was set to 30 μm.

### 7. Joining of Negative Electrode Exposed Surface of Laminated Integrated Sintered Body and Aluminum Foil via Conductive Carbon Paste

Aluminum foil serving as a negative electrode collector was bonded to the negative electrode exposed surface of the laminated integrated sintered body via a conductive carbon adhesion layer in the same manner as in the section 6.

### 8. Production of Lithium Secondary Battery

The positive electrode collector, the laminated integrated sintered body, and the negative electrode collector were placed between a positive electrode can and a negative electrode can, which were intended to form a battery case, so that the collectors and the sintered body were laminated in the stated order from the positive electrode can to the negative electrode can, followed by the loading of an electrolytic solution. After that, the positive electrode can and the negative electrode can were sealed by caulking through a gasket. Thus, a lithium secondary battery of a coin cell form having a diameter of 20 mm and a thickness of 1.6 mm was produced. [FIG. 9] shows a schematic perspective view of the external appearance of a lithium secondary battery. A liquid obtained as follows was used as the electrolytic solution: propylene carbonate (PC) and Y-butyrolactone (GBL) were mixed at a volume ratio of 1:3; and LiPF₆ was dissolved in the resultant organic solvent so that its concentration became 1.5 mol/L.

### Comparative Example 1

The lithium secondary battery was produced in the same manner as in Example 1 except for the cutting of the green sheets and the position at which the green sheet laminate was cut.

In Comparative Example 1, the positive electrode green sheet and the negative electrode green sheet were each cut into a rectangular shape of 20 mm×20 mm. The separator green sheet was cut into a rectangular shape of 25 mm×25 mm. After that, various green sheets were laminated and pressed in the same manner as in Example 1.

The pressed laminate was cut at a position at which the positive electrode layer and the separator were exposed (no negative electrode layer was exposed) at one of both of the side surfaces, and a position at which the negative electrode layer and the separator were exposed (no positive electrode layer was exposed) at another of both of the side surfaces. Further, the front surface and the back surface of the laminate were both cut at positions at which the positive electrode layer, the separator, and the negative electrode layer were exposed. The dimensions of the green sheet laminate after cutting were set to 10 mm×10 mm similarly to Example 1.

### Example 2

The positive electrode green sheet, the negative electrode green sheet, and the separator green sheet were produced in the same manner as in Example 1.

In the step of cutting the green sheet, each of the positive electrode green sheet and the negative electrode green sheet was punched out with a circle puncher of a diameter of 15.5 mm so that a circular green sheet was obtained. Further, each of the circular green sheets was linearly cut at a position of 2 mm in the center direction from one point of the end surface, in parallel to a tangent line at this point.

Next, in the order of lamination similar to Example 1, various green sheets were laminated so that the number of cells to be formed in the laminate became fifteen. As illustrated in [FIGS. 6], the positive electrode green sheet and the negative electrode green sheet were arranged so that the respective cut end surfaces were positioned to be opposed to each other across the center of the circle. Subsequently, the green sheet laminate was pressed under conditions similar to those of Example 1, and the green sheets were pressure-bonded to each other.

The pressure-bonded green sheet laminate was punched out with a hand puncher of a diameter of 16 mm. Further, as illustrated in [FIGS. 6], two portions were cut along two parallel straight lines. The cutting positions were set to a position at which the positive electrode and the separator were exposed and no negative electrode layer was exposed at one end surface, and a position at which the negative electrode layer and the separator were exposed and no positive electrode layer was exposed at the other end surface.

Subsequently, the degreasing and the firing were executed in the same manner as in Example 1. Thus, a round-shape multi-layer laminating-type sintered body in which the peripheral end was covered with the separator (insulating ceramic portion) was obtained.

Aluminum foil serving as the positive electrode collector was arranged through a conductive carbon paste on the surface at which the positive electrode and the separator were exposed. Further, aluminum foil serving as the negative electrode collector was arranged through a conductive carbon paste on the surface at which the negative electrode and the separator were exposed.

The lithium secondary battery was assembled in the same manner as in Example 1.

### Comparative Example 2

The positive electrode green sheet, the negative electrode green sheet, and the separator green sheet were produced in the same manner as in Example 1. The positive electrode green sheet and the negative electrode green sheet were each cut into a rectangular shape of 20 mm×20 mm in the same manner as in Comparative Example 1. The separator green sheet was cut into a rectangular shape of 25 mm×25 mm. After that, various green sheets were laminated and pressed in the same manner as in Example 1.

Next, in the order of lamination and the lamination position similar to Example 1, various green sheets were laminated so that the number of cells to be formed in the laminate became fifteen. Subsequently, the green sheet laminate was pressed under conditions similar to those of Example 1, and the green sheets were pressure-bonded to each other.

The pressure-bonded green sheet laminate was punched out with a hand puncher of a diameter of 16 mm. Further, two portions were cut along two parallel straight lines. The cutting positions were set to a position at which the positive electrode and the separator were exposed and no negative electrode layer was exposed at one end surface, and a position at which the negative electrode layer and the separator were exposed and no positive electrode layer was exposed at the other end surface.

Subsequently, the degreasing and the firing were executed in the same manner as in Example 1. Thus, a round-shape multi-layer laminating-type sintered body in which the positive electrode layer and the negative electrode layer were exposed at the two cut end surfaces, respectively, and the end surfaces of the positive electrode layer, the negative electrode layer, and the separator were exposed at the peripheral end other than the cut end surfaces was obtained.

Aluminum foil serving as the positive electrode collector was arranged through a conductive carbon paste on the surface at which the positive electrode and the separator were exposed. Further, aluminum foil serving as the negative electrode collector was arranged through a conductive carbon paste on the surface at which the negative electrode and the separator were exposed.

The lithium secondary battery was assembled in the same manner as in Example 1.

### Example 3

The positive electrode green sheet was produced in the same manner as in Example 1 except that the thickness after the firing became 100 μm. The negative electrode green sheet was produced in the same manner as in Example 1 except that the thickness after the firing became 100 μm. The separator green sheet was produced in the same manner as in Example 1.

In the lamination, seven positive electrode green sheets and three negative electrode green sheets each being cut into 20 mm×20 mm were separately laminated and were pressed by CIP at 100 kgf/cm² so that the green sheets were pressure-bonded to each other. Next, the laminate was punched out with a circle puncher of a diameter of 15.5 mm, and thus a round-shape positive electrode tentative t laminate and a round-shape negative electrode tentative laminate illustrated in part (1) of [FIG. 8A] were obtained. After that, the separator green sheets were also laminated and pressure-bonded in a similar procedure so as to have the same thickness as those of the positive electrode tentative laminate and the negative electrode tentative laminate, and were punched out with a circle puncher of a diameter of 15.5 mm. Thus, a separator tentative laminate having a round hole with a diameter of 15.5 mm was obtained as illustrated in part (2) of [FIG. 8B]. Each of the positive electrode tentative laminate and the negative electrode tentative laminate was fitted to the round hole of the separator tentative laminate having the same thickness as the thickness of each of the tentative laminates, and the laminating and pressure-bonding process was performed while the separator green sheet was sandwiched therebetween. The obtained laminate was punched out into a cylindrical shape through use of a circle puncher of a diameter of 16 mm. Thus, as illustrated in part (4) of [FIG. 8D], an un-sintered green sheet laminate in which the insulating ceramic portion of 0.25 mm was formed on the peripheral end of the laminate portion having the diameter of 15.5 mm was obtained. The degreasing and the sintering were executed in the same manner as in Example 1. Thus, a sintered body in which one positive electrode layer, the separator, and one negative electrode layer are integrally sintered and which includes the insulating ceramic portion on the peripheral end was obtained. The lithium secondary battery was produced in the same manner as in Example 1.

### Comparative Example 3

The positive electrode green sheet and the negative electrode green sheet were produced in the same manner as in Example 3. The separator green sheet was produced in the same manner as in Example 1. Seven positive electrode green sheets, one separator green sheet, and three negative electrode green sheets each being cut into 20 mm×20 mm were laminated in the stated order and were pressed by CIP at 100 kgf/cm² so that the green sheets were pressure-bonded to each other. The laminate was punched out with a circle puncher of a diameter of 16 mm into a cylindrical shape, and thus an unfired green sheet laminate was obtained. The degreasing and the sintering were executed in the same manner as in Example 1. Thus, a round-shape sintered body in which one positive electrode layer, the separator, and one negative electrode layer were integrally sintered was obtained. The positive electrode layer, the separator, and the negative electrode layer were exposed at the peripheral end of the sintered body. The lithium secondary battery was produced in the same manner as in Example 1.

### [Evaluation]

The resultant lithium secondary batteries of Examples 1 to 3 and Comparative Examples 1 to 3 were evaluated by methods described in Evaluations 1 and 2.

### Evaluation 1. Evaluation of Battery Performance (Evaluation of 0.2 C Discharge Capacity)

The battery capacity of the resultant battery was determined in an environment at 25° C. The battery was charged at a constant current of 0.2 C, and the charge was performed until its voltage reached 2.7 V. The battery was discharged at a constant current of 0.2 C, and the discharge was performed until its voltage reached 1.5 V. The second cycle of charge and discharge was performed under the same conditions as those of the first cycle, and a discharge capacity in the second cycle was defined as a 0.2 C discharge capacity.

### Evaluation 2. Evaluation of Self-discharge Rate

The battery whose 0.2 C discharge capacity has been checked was recharged at a constant current of 0.2 C, and the charge was performed until its voltage reached 2.7 V. After that, the charged battery was brought into an open circuit state, and was stably placed under an environment of 85° C. for five days to promote the self-discharge. The battery whose stable placement has been ended was discharged until its voltage reached 1.5 V at a constant current of 0.2 C. Thus, a discharge capacity after being left for five days at 85° C. after full-charge was obtained.

The self-discharge rate was derived by the following calculation equation from the 0.2 C discharge capacity obtained in Evaluation 1 and the discharge capacity after being left for five days at 85° C. after full-charge.

$$Self - discharge rate ( \% ) = 100 \times ( ( 0.2 C discharge capacity ) - ( discharge capacity after being left for five days at 85 ° C . after full - charge ) ) / 0.2 C discharge capacity )$$

The evaluation results of the lithium secondary batteries of Examples 1 to 3 and Comparative Examples 1 to 3 are summarized in [Table 1].

TABLE 1

| | | | | | Discharge | | | |
|---|---|---|---|---|---|---|---|---|
| | | | | | capacity | | | |
| | | | | | after being | | | |
| | | | | | left for five | | | |
| | | Insulating | 0.2 C | | days at 85° C. | | Self- | |
| | Electrode | ceramic | discharge | | after full- | | discharge | Comprehensive |
| | shape | portion | capacity | | charge | | rate | evaluation |
| Example 1 | Multi- | Present | 5.8 | mAh | 4.6 | mAh | 19% | ∘ |
| Comparative | layer | Absent | 6.0 | mAh | 3.2 | mAh | 47% | x |
| Example 1 | rectangular | | | | | | | |
| | shape | | | | | | | |
| Example 2 | Multi- | Present | 8.7 | mAh | 7.3 | mAh | 16% | ∘ |
| Comparative | layer | Absent | 9.2 | mAh | 5.1 | mAh | 45% | x |
| Example 2 | round | | | | | | | |
| | shape | | | | | | | |
| Example 3 | One-layer | Present | 17.4 | mAh | 14.4 | mAh | 17% | ∘ |
| Comparative | round | Absent | 18.8 | mAh | 13.5 | mAh | 28% | x |
| Example 3 | shape | | | | | | | |

Example 1 and Comparative Example 1 include multi-layer rectangular-shape electrodes including the same number of cells, and are different from each other only in whether the insulating ceramic portion is present or absent on the peripheral end of the laminate portion. Similarly, Example 2 and Comparative Example 2 both include multi-layer round-shape electrodes including the same number of cells, and are different from each other only in whether the insulating ceramic portion is present or absent on the peripheral end of the laminate portion. Example 3 and Comparative Example 3 each include an electrode including one positive electrode layer, the separator, and one negative electrode layer. Example 3 and Comparative Example 3 are different from each other only in whether the insulating ceramic portion is present or absent on the peripheral end.

With reference to Table 1, all lithium secondary batteries of Examples 1 to 3 exhibited 0.2 C discharge capacities of the same level as each of Comparative Examples 1 to 3 including no insulating ceramic portion on the peripheral end. That is, in each of the lithium secondary batteries of Examples 1 to 3, a high-capacity lithium secondary battery that can be obtained by using the integrated sintered electrode is achieved. Further, regarding the self-discharge rate, when Example and Comparative Example corresponding to each other (Example 1 and Comparative Example 1, Example 2 and Comparative Example 2, and Example 3 and Comparative Example 3) are compared with each other, Example is reduced in self-discharge rate to from about ½ to about ⅓ of that of Comparative Example. That is, it was confirmed that the self-discharge rate was reduced to from about ½ to about ⅓ when the insulating ceramic portion was included on the peripheral end of the laminate portion in the sintered body.

It is to be understood that the embodiments disclosed herein are merely examples in all aspects and in no way intended to limit the present disclosure. The scope of the present disclosure is defined by the appended claims and not by the above description, and it is intended that the present disclosure encompasses all modifications made within the scope and spirit equivalent to those of the appended claims.

### REFERENCE SIGNS LIST

1 laminate, 5 electrode, 10 lithium secondary battery, 12 positive electrode layer, 16 negative electrode layer, 14 positive electrode collector, 18 negative electrode collector, 20 separator, 22 electrolytic solution, 24 exterior body, 24a positive electrode can, 24b negative electrode can, 24c gasket, 51, 52 insulating layer, 9, 91, 92 sintered body, 101 green sheet laminate, 112 positive electrode green sheet, 116 negative electrode green sheet, 120 separator green sheet

1. A lithium secondary battery, comprising a sintered body, the sintered body including a laminate portion which includes a positive electrode layer, a negative electrode layer, and a separator, and in which the positive electrode layer and the negative electrode layer are laminated through the separator,
wherein the sintered body includes an insulating ceramic portion covering at least a part of a peripheral end of the laminate portion and extending across at least a part of a laminate structure exposed at the peripheral end of the laminate portion.

2. The lithium secondary battery according to claim 1, wherein the insulating ceramic portion is sintered integrally with the laminate portion.

3. The lithium secondary battery according to claim 1, wherein the insulating ceramic portion and the separator are formed of the same composition.

4. The lithium secondary battery according to claim 1, wherein the sintered body has a surface including:
a surface covered with the insulating ceramic portion;
a surface at which the positive electrode layer is exposed and the negative electrode layer is not exposed; and
a surface at which the negative electrode layer is exposed and the positive electrode layer is not exposed.

5. The lithium secondary battery according to claim 3, wherein the sintered body has a surface including:
a surface covered with the insulating ceramic portion;
a surface at which the positive electrode layer is exposed and the negative electrode layer is not exposed; and
a surface at which the negative electrode layer is exposed and the positive electrode layer is not exposed.

6. The lithium secondary battery according to claim 1,
wherein the laminate portion includes a plurality of positive electrode layers, a plurality of negative electrode layers, and a separator, and
wherein the plurality of positive electrode layers and the plurality of negative electrode layers are alternately laminated through the separator.

7. The lithium secondary battery according to claim 1,
wherein the positive electrode layer includes a lithium composite oxide sintered body, and
wherein the negative electrode layer includes a titanium-containing sintered body.

8. The lithium secondary battery according to claim 2, wherein the insulating ceramic portion and the separator are formed of the same composition.

9. The lithium secondary battery according to claim 2, wherein the sintered body has a surface including:
a surface covered with the insulating ceramic portion;
a surface at which the positive electrode layer is exposed and the negative electrode layer is not exposed; and
a surface at which the negative electrode layer is exposed and the positive electrode layer is not exposed.

10. The lithium secondary battery according to claim 2,
wherein the laminate portion includes a plurality of positive electrode layers, a plurality of negative electrode layers, and a separator, and
wherein the plurality of positive electrode layers and the plurality of negative electrode layers are alternately laminated through the separator.

11. The lithium secondary battery according to claim 2,
wherein the positive electrode layer includes a lithium composite oxide sintered body, and
wherein the negative electrode layer includes a titanium-containing sintered body.
